(19) United States
(12) Patent Application Publication
(10) Pub. No.: US 2026/0219691 A1
(43) Pub. Date: Jul. 30, 2026

(54) ROBOT AND OPERATION METHOD THEREOF

(71) Applicant: LG ELECTRONICS INC., Seoul (KR)

(72) Inventors: Sangyeun YOO, Seoul (KR); Hyeongshin JEON, Seoul (KR)

(73) Assignee: LG ELECTRONICS INC., Seoul (KR)

(21) Appl. No.: 19/151,583

(22) PCT Filed: Feb. 8, 2023
(86) PCT No.: PCT/KR2023/001850

§ 371 Date: Jul. 28, 2025

(51) Int. Cl. G05D 1/667; B66F 9/06; B66F 9/065; G01S 17/931; G05D 1/242; G05D 111/10

(52) U.S. Cl. CPC G05D 1/667; B66F 9/063; B66F 9/065; G01S 17/931; G05D 1/242; G05D 2111/17

(57) ABSTRACT

A robot comprising: a driving module; a lift provided on top of the driving module; a first lidar disposed on one side of the driving module; a second lidar disposed on the driving module, distanced from the first lidar; and a processor for controlling the driving module in response to results of sensing by the first and second lidars, wherein the first and second lidars may be installed so as to differ in roll and/or pitch.

### TECHNICAL FIELD

The present disclosure relates to a robot and a method for operating the same.

### BACKGROUND ART

A robot is a machine that automatically processes or operates a given task by own capabilities thereof, and the application fields of robots can be generally classified into industrial, medical, space, subsea use, and the like and can be used in various fields.

An example of a robot might be an industrial robot that carries a cart loaded with parts to a destination in a manufacturing plant, and such a robot might include a lidar to detect the legs of the cart.

Industrial robots may be used on uneven surfaces, in which case the industrial robot's lidar may not detect the legs of the cart and may malfunction.

### DISCLOSURE

### Technical Problem

An object of the present embodiment is to provide a robot capable of reliably detecting the legs of a cart and minimizing cart recognition errors due to floor inclination, and a method operating the same.

### Technical Solution

According to the present embodiment, a robot includes a driving module; a lift installed on an upper side of the driving module; a first lidar disposed on one side of the driving module; a second lidar disposed spaced apart from the first lidar on the driving module, and a processor configured to control the driving module according to the sensing results of the first lidar and the sensing results of the second lidar, at least one of a roll and pitch of the first and second lidars is different from each other.

The processor may drive the driving module to a docking position of a cart if at least one of the first lidar and the second lidar normally recognizes a leg of the cart.

The first lidar and the second lidar may have the same yaw.

The first lidar and the second lidar may be disposed spaced apart from each other in front surface of the driving module in a left and right direction.

The first lidar may be disposed to be inclined toward the front upper direction.

A maximum inclination angle of the first lidar may be +1.5°.

The second lidar may be disposed to be inclined toward the front lower direction.

A maximum inclination angle of the second lidar may be −1.5°.

A method for operating a robot may include sensing a leg of a cart by a first lidar and a second lidar in which at least one of the roll and pitch is installed differently; and driving a driving module to a docking position of the cart if at least one of the first lidar and the second lidar normally recognizes the leg of the cart.

The method for operating a robot may further include raising a lift disposed on the driving module if the driving module reaches the docking position of the cart.

The method for operating a robot may further include driving a driving module to a destination after the lift is raised.

### Advantageous Effect

According to the present embodiment, at least one of a roll and pitch of the first and second lidars is different from each other, so that even if the floor is inclined or uneven, one of the two lidars can reliably detect the leg of the cart, and cart recognition errors can be minimized due to the floor being inclined.

### DESCRIPTION OF DRAWINGS

FIG. 1 illustrates an AI device including a robot according to an embodiment of the present disclosure;

FIG. 2 illustrates an AI server connected to a robot according to an embodiment of the present disclosure;

FIG. 3 illustrates an AI system 1 according to an embodiment of the present disclosure;

FIG. 4 is a perspective view illustrating an example of a robot and a cart according to the present embodiment;

FIG. 5 is a plan view when a pair of lidars according to the present embodiment detects the legs of a cart;

FIG. 6 is a perspective view when a pair of lidars according to the present embodiment detects the legs of a cart;

FIG. 7 is a plan view illustrating a pair of lidars according to the present embodiment when the rolls are installed differently as example of a robot;

FIG. 8 is a perspective view illustrating a pair of lidars according to the present embodiment when the rolls are installed differently;

FIG. 9 is a perspective view illustrating a pair of lidars according to the present embodiment when the pitches are installed differently;

FIG. 10 is a side view illustrating a pair of lidars according to the present embodiment when the pitches are installed differently;

FIG. 11 is a side view illustrating an example of a robot according to the present embodiment when detecting a cart leg;

FIG. 12 is a view illustrating the sensing values of the first lidar and the sensing values of the second lidar illustrated in FIG. 11;

FIG. 13 is a flow chart for detecting the legs of a cart by a pair of lidars according to the present embodiment;

FIG. 14 is a side view illustrating when both a pair of lidars according to the present embodiment normally detect the legs of the cart;

FIG. 15 is a view illustrating an example of sensing values when both a pair of lidars according to the present embodiment normally detect the legs of a cart;

FIG. 16 is a side view illustrating when only one of a pair of lidars according to the present embodiment normally detects the leg of the cart;

FIG. 17 is a view illustrating an example of sensing values when only one of a pair of lidars according to the present embodiment normally detects the leg of a cart;

FIG. 18 is a side view illustrating a case where neither pair of lidars according to the present embodiment detects the legs of the cart normally;

FIG. 19 is a view illustrating an example of sensing values in a case where both a pair of lidars according to the present embodiment fail to normally detect the legs of a cart; and

FIG. 20 is a plan view illustrating a robot according to the present embodiment when moving to a docking position.

### BEST MODE

Hereinafter, specific embodiments of the present invention will be described in detail with drawings.

Hereinafter, when it is described that an element is “fastened” or “connected” to another element, it may mean that the two elements are directly fastened or connected, or that a third element exists between the two elements and that the two elements are fastened or connected to each other by said third element. On the other hand, when it is described that an element is “directly fastened” or “directly connected” to another element, it may be understood that no third element exists between the two elements.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

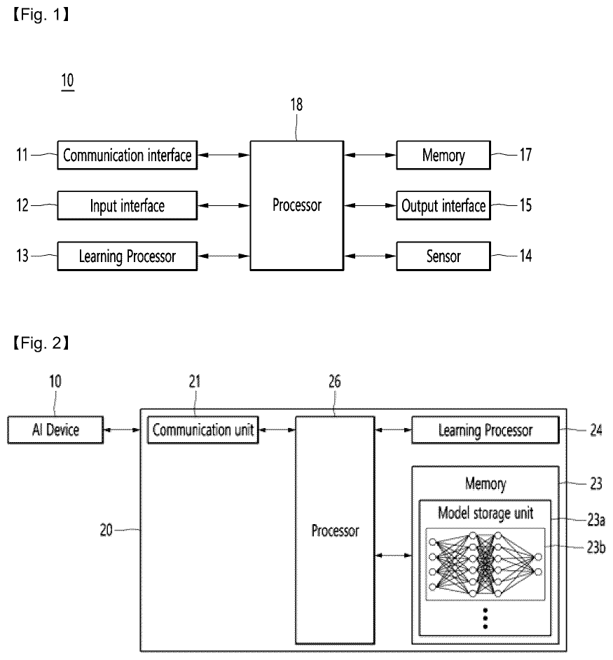

FIG. 1 illustrates an AI device including a robot according to an embodiment of the present disclosure.

The AI device 10 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 10 may include a communication interface 11, an input interface 12, a learning processor 13, a sensor 14, an output interface 15, a memory 17, and a processor 18.

The communication interface 11 may transmit and receive data to and from external devices such as other AI devices 10a to 10e and the AI server 20 by using wire/wireless communication technology. For example, the communication interface 11 may transmit and receive sensor information, a user input, a learning model, and a control signal to and from external devices.

The communication technology used by the communication interface 11 includes GSM (Global System for Mobile communication), CDMA (Code Division Multi Access), LTE (Long Term Evolution), 5G, WLAN (Wireless LAN), Wi-Fi (Wireless-Fidelity), Bluetooth, RFID (Radio Frequency Identification), Infrared Data Association (IrDA), ZigBee, NFC (Near Field Communication), and the like.

The input interface 12 may acquire various kinds of data.

At this time, the input interface 12 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 12 may acquire a learning data for model learning and an input data to be used when an output is acquired by using learning model. The input interface 12 may acquire raw input data. In this case, the processor 18 or the learning processor 13 may extract an input feature by preprocessing the input data.

The learning processor 13 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 13 may perform AI processing together with the learning processor 24 of the AI server 20.

At this time, the learning processor 13 may include a memory integrated or implemented in the AI device 10. Alternatively, the learning processor 13 may be implemented by using the memory 17, an external memory directly connected to the AI device 10, or a memory held in an external device.

The sensor 14 may acquire at least one of internal information about the AI device 10, ambient environment information about the AI device 10, and user information by using various sensors.

Examples of the sensors included in the sensor 14 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 15 may generate an output related to a visual sense, an auditory sense, or a haptic sense.

At this time, the output interface 15 may include a display unit for outputting time information, a speaker for outputting auditory information, and a haptic module for outputting haptic information.

The memory 17 may store data that supports various functions of the AI device 10. For example, the memory 17 may store input data acquired by the input interface 12, learning data, a learning model, a learning history, and the like.

The processor 18 may determine at least one executable operation of the AI device 10 based on information determined or generated by using a data analysis algorithm or a machine learning algorithm. The processor 18 may control the components of the AI device 10 to execute the determined operation.

To this end, the processor 18 may request, search, receive, or utilize data of the learning processor 13 or the memory 17. The processor 18 may control the components of the AI device 10 to execute the predicted operation or the operation determined to be desirable among the at least one executable operation.

When the connection of an external device is required to perform the determined operation, the processor 18 may generate a control signal for controlling the external device and may transmit the generated control signal to the external device.

The processor 18 may acquire intention information for the user input and may determine the user's requirements based on the acquired intention information.

The processor 18 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 13, may be learned by the learning processor 24 of the AI server 20, or may be learned by their distributed processing.

The processor 18 may collect history information including the operation contents of the AI apparatus 100 or the user's feedback on the operation and may store the collected history information in the memory 17 or the learning processor 13 or transmit the collected history information to the external device such as the AI server 20. The collected history information may be used to update the learning model.

The processor 18 may control at least part of the components of AI device 10 so as to drive an application program stored in memory 17. Furthermore, the processor 18 may operate two or more of the components included in the AI device 10 in combination so as to drive the application program.

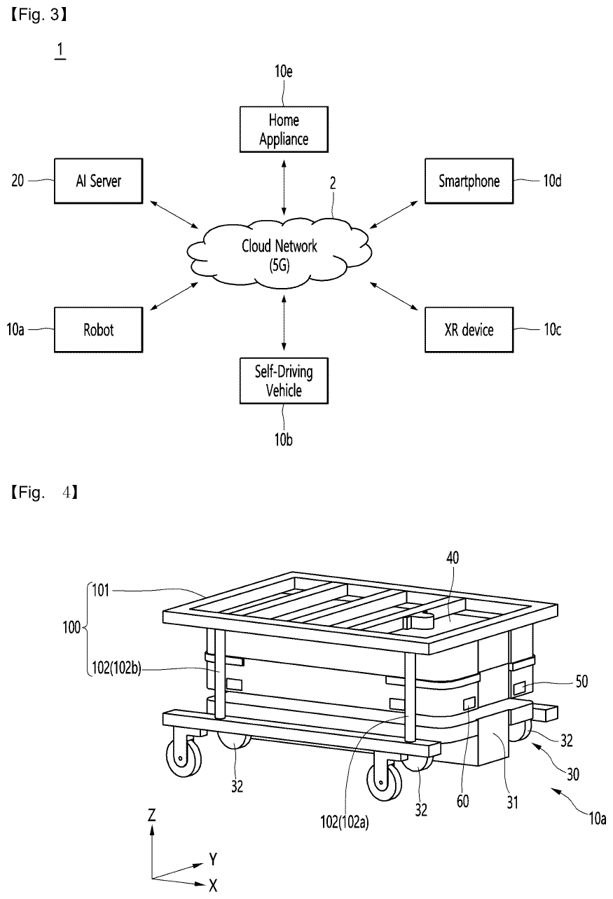

FIG. 2 illustrates an AI server connected to a robot according to an embodiment of the present disclosure.

Referring to FIG. 2, the AI server 20 may refer to a device that learns an artificial neural network by using a machine learning algorithm or uses a learned artificial neural network. The AI server 20 may include a plurality of servers to perform distributed processing, or may be defined as a 5G network. At this time, the AI server 20 may be included as a partial configuration of the AI device 10, and may perform at least part of the AI processing together.

The AI server 20 may include a communication interface 21, a memory 23, a learning processor 24, a processor 26, and the like.

The communication interface 21 can transmit and receive data to and from an external device such as the AI device 10.

The memory 23 may include a model storage unit 23a. The model storage unit 23a may store a learning or learned model (or an artificial neural network 26b) through the learning processor 24.

The learning processor 24 may learn the artificial neural network 26b by using the learning data. The learning model may be used in a state of being mounted on the AI server 20 of the artificial neural network, or may be used in a state of being mounted on an external device such as the AI device 10.

The learning model may be implemented in hardware, software, or a combination of hardware and software. If all or part of the learning models are implemented in software, one or more instructions that constitute the learning model may be stored in memory 23.

The processor 26 may infer the result value for new input data by using the learning model and may generate a response or a control command based on the inferred result value.

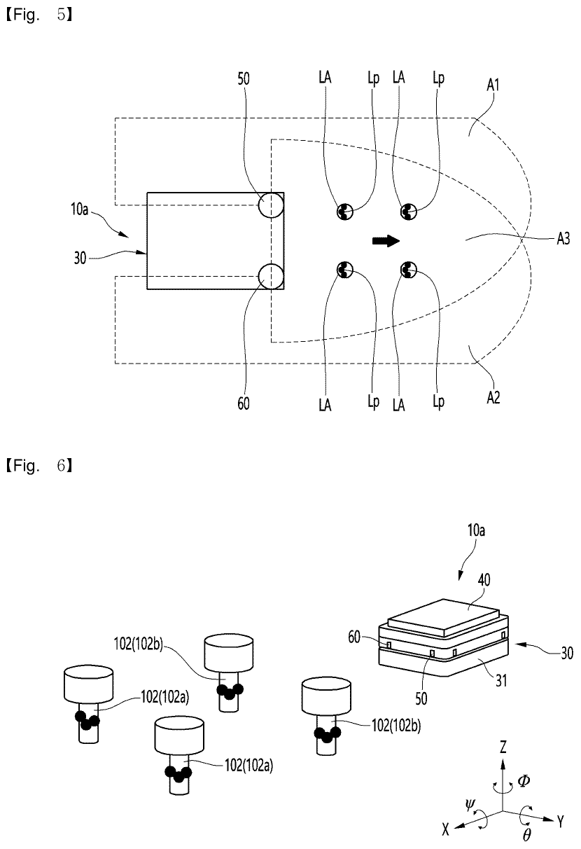

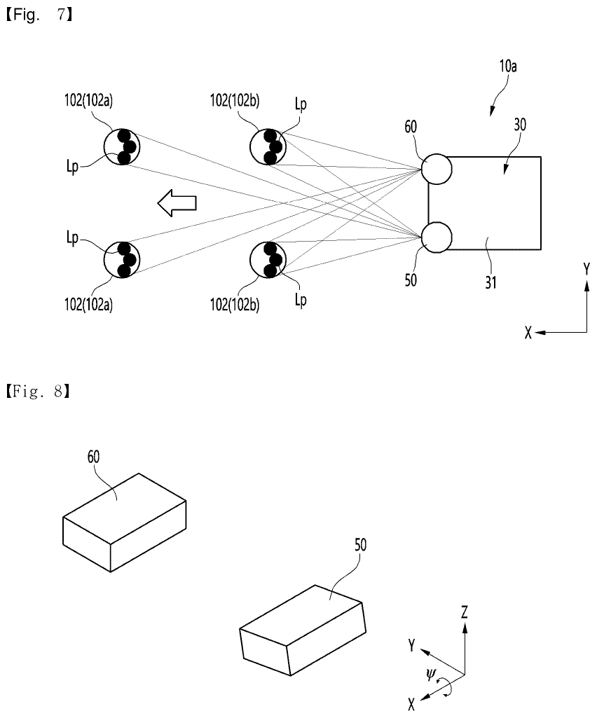

FIG. 3 illustrates an ai system 1 according to an embodiment of the present disclosure.

Referring to FIG. 3, in the AI system 1, at least one of an AI server 20, a robot 10a, a self-driving vehicle 10b, an XR device 10c, a smartphone 10d, or a home appliance 10e is connected to a cloud network 2. The robot 10a, the self-driving vehicle 10b, the XR device 10c, the smartphone 10d, or the home appliance 10e, to which the AI technology is applied, may be referred to as AI devices 10a to 10e.

The cloud network 2 may refer to a network that forms part of a cloud computing infrastructure or exists in a cloud computing infrastructure. The cloud network 2 may be configured by using a 3G network, a 4G or LTE network, or a 5G network.

That is, the devices 10 a to 10 e and 20 configuring the AI system 1 may be connected to each other through the cloud network 2. In particular, each of the devices 10a to 10 e and 20 may communicate with each other through a base station, but may directly communicate with each other without using a base station.

The AI server 20 may include a server that performs AI processing and a server that performs operations on big data.

The AI server 20 may be connected to at least one of the AI devices constituting the AI system 1, that is, the robot 10a, the self-driving vehicle 10b, the XR device 10c, the smartphone 10d, or the home appliance 10e through the cloud network 2, and may assist at least part of AI processing of the connected AI devices 10a to 10e.

At this time, the AI server 20 may learn the artificial neural network according to the machine learning algorithm instead of the AI devices 10a to 10e, and may directly store the learning model or transmit the learning model to the AI devices 10a to 10e.

At this time, the AI server 20 may receive input data from the AI devices 10a to 10e, may infer the result value for the received input data by using the learning model, may generate a response or a control command based on the inferred result value, and may transmit the response or the control command to the AI devices 10a to 10e.

Alternatively, the AI devices 10a to 10e may infer the result value for the input data by directly using the learning model, and may generate the response or the control command based on the inference result.

Hereinafter, various embodiments of the AI devices 10a to 10e to which the above-described technology is applied will be described. The AI devices 10a to 10e illustrated in FIG. 3 may be regarded as a specific embodiment of the AI device 10 illustrated in FIG. 1.

### AI+Robot

The robot 10a, to which the AI technology is applied, may be implemented as a guide robot, a carrying robot, a cleaning robot, a wearable robot, an entertainment robot, a pet robot, an unmanned flying robot, or the like.

The robot 10a may include a robot control module for controlling the operation, and the robot control module may refer to a software module or a chip implementing the software module by hardware.

The robot 10a may acquire state information about the robot 10a by using sensor information acquired from various kinds of sensors, may detect (recognize) surrounding environment and objects, may generate map data, may determine the route and the travel plan, may determine the response to user interaction, or may determine the operation.

The robot 10a may use the sensor information acquired from at least one sensor among the lidar, the radar, and the camera so as to determine the travel route and the travel plan.

The robot 10a may perform the above-described operations by using the learning model composed of at least one artificial neural network. For example, the robot 10a may recognize the surrounding environment and the objects by using the learning model, and may determine the operation by using the recognized surrounding information or object information. The learning model may be learned directly from the robot 10a or may be learned from an external device such as the AI server 20.

At this time, the robot 10a may perform the operation by generating the result by directly using the learning model, but the sensor information may be transmitted to the external device such as the AI server 20 and the generated result may be received to perform the operation.

The robot 10a may use at least one of the map data, the object information detected from the sensor information, or the object information acquired from the external apparatus to determine the travel route and the travel plan, and may control the driving unit such that the robot 10a travels along the determined travel route and travel plan.

The map data may include object identification information about various objects disposed in the space in which the robot 10a moves. For example, the map data may include object identification information about fixed objects such as walls and doors and movable objects such as pollen and desks. The object identification information may include a name, a type, a distance, and a position.

In addition, the robot 10a may perform the operation or travel by controlling the driving unit based on the control/interaction of the user. At this time, the robot 10a may acquire the intention information of the interaction due to the user's operation or speech utterance, and may determine the response based on the acquired intention information, and may perform the operation.

### AI+Robot+Self-Driving

The robot 10a, to which the AI technology and the self-driving technology are applied, may be implemented as a guide robot, a carrying robot, a cleaning robot, a wearable robot, an entertainment robot, a pet robot, an unmanned flying robot, or the like.

The robot 10a, to which the AI technology and the self-driving technology are applied, may refer to the robot itself having the self-driving function or the robot 10a interacting with the self-driving vehicle 10b.

The robot 10a having the self-driving function may collectively refer to a device that moves for itself along the given movement line without the user's control or moves for itself by determining the movement line by itself.

The robot 10a and the self-driving vehicle 10b having the self-driving function may use a common sensing method so as to determine at least one of the travel route or the travel plan. For example, the robot 10a and the self-driving vehicle 10b having the self-driving function may determine at least one of the travel route or the travel plan by using the information sensed through the lidar, the radar, and the camera.

The robot 10a that interacts with the self-driving vehicle 10b exists separately from the self-driving vehicle 10b and may perform operations interworking with the self-driving function of the self-driving vehicle 10b or interworking with the user who rides on the self-driving vehicle 10b.

At this time, the robot 10a interacting with the self-driving vehicle 10b may control or assist the self-driving function of the self-driving vehicle 10b by acquiring sensor information on behalf of the self-driving vehicle 10b and providing the sensor information to the self-driving vehicle 10b, or by acquiring sensor information, generating environment information or object information, and providing the information to the self-driving vehicle 10b.

Alternatively, the robot 10a interacting with the self-driving vehicle 10b may monitor the user boarding the self-driving vehicle 10b, or may control the function of the self-driving vehicle 10b through the interaction with the user. For example, when it is determined that the driver is in a drowsy state, the robot 10a may activate the self-driving function of the self-driving vehicle 10b or assist the control of the driving unit of the self-driving vehicle 10b. The function of the self-driving vehicle 10b controlled by the robot 10a may include not only the self-driving function but also the function provided by the navigation system or the audio system provided in the self-driving vehicle 10b.

Alternatively, the robot 10a that interacts with the self-driving vehicle 10b may provide information or assist the function to the self-driving vehicle 10b outside the self-driving vehicle 10b. For example, the robot 10a may provide traffic information including signal information and the like, such as a smart signal, to the self-driving vehicle 10b, and automatically connect an electric charger to a charging port by interacting with the self-driving vehicle 10b like an automatic electric charger of an electric vehicle.

The robot 10a may be a guide robot that provides various information to users at airports, subways, bus terminals, or the like, a serving robot that can serve various items to guests at restaurants, hotels, or the like, a delivery robot that can transport items such as food, medicine, and delivery items (hereinafter referred to as “items”), or an industrial robot that transports a cart loaded with parts to a destination at a factory, or the like.

The robot 10a of this embodiment may be an industrial robot capable of transporting a cart 100 (see FIG. 4) to a destination, and may be, for example, an AMR (Autonomous Mobile Robots).

FIG. 4 is a perspective view illustrating an example of a robot and a cart according to the present embodiment; FIG. 5 is a plan view when a pair of lidars according to the present embodiment detects the legs of a cart; FIG. 6 is a perspective view when a pair of lidars according to the present embodiment detects the legs of a cart; and FIG. 7 is a plan view illustrating a pair of lidars according to the present embodiment when the rolls are installed differently as example of a robot.

The robot 10a may include a driving module 30; a lift 40 installed on the upper side of the driving module 30; and a pair of lidars 50, 60 disposed on the driving module 30.

The driving module 30 may include a main body 31, a driving wheel 32 positioned at the lower portion of the main body 31, and a driving motor (not illustrated) that rotates the driving wheel 32.

A plurality of driving wheels 32 and driving motors may be provided on the main body 31. A plurality of driving wheels 32 can roll along the ground (floor surface).

The lift 40 may be configured to raise and lower the cart 100. The lift 40 may include a raising and lowering plate that is raised and lowered from the upper side of the driving module 30. The lift 40 may be disposed on the lower side of the raising and lowering plate, and may further include a raising and lowering drive source (not illustrated) that raises and lowers the raising and lowering plate.

The raising and lowering drive source may be composed of an actuator such as a motor or cylinder. The raising and lowering drive source may be installed in the driving module 30, particularly in the main body 31.

A cart 100 may include an upper body 101 on which various components or products are placed, and a plurality of legs 102 that support the upper body 101.

An empty space may be formed on the lower side of the upper body 101, and this empty space may be a robot entry space into which the robot 10a enters, or a docking space into which the robot 10a may be docked.

At least four legs 102 may be provided on the upper body 101, and the plurality of legs 102 may include a pair of front legs 102a and a pair of rear legs 102b.

The gap between a pair of front legs 102a can be larger than the width of the robot 10a in the left and right direction Y, and the robot 10a can enter/dock underneath the upper body 101 through the gap between the pair of front legs 102a.

The robot 10a can detect the cart 100 from the outside of the cart 100, enter the detected cart 100, and then raise the lift 40 after completing entry into the cart 100.

When the robot 10a completes entering the lower portion of the upper body 101, that is, the entry space, as illustrated in FIG. 4, the lift 40 can be raised from the lower portion of the upper body 101, and the lift 40 can separate the cart 100 from the ground.

Afterwards, the robot 10a can move the cart 100 to the destination by driving the driving module 30, and when reaching the destination, the lift 40 can be lowered to transport the cart 100 to the destination.

A pair of lidars 50, 60 may comprise a first lidar 50 and a second lidar 60 spaced apart in the left and right direction Y, as illustrated in FIGS. 4 to 7.

The first lidar 50 may be disposed on one side of the driving module 30.

The second lidar 60 may be disposed in the driving module 30 apart from the first lidar 50.

The first lidar 50 and the second lidar 60 may be disposed on the left and right sides of the front surface of the robot 10a, especially on the front surface of the driving module 30. The first lidar 50 and the second lidar 60 may be disposed at the same height. In other words, the first lidar 50 and the second lidar 60 can be disposed spaced apart in the left and right direction Y on the front surface of the driving module 30 and have the same installation height.

Each of the first lidar 50 and the second lidar 60 may include a cart recognition module. The cart recognition module may recognize the leg 102 of the cart 100.

As illustrated in FIG. 5, the first lidar 50 may detect a first area A1 on the left and front of the robot 10a, the second lidar 60 may detect a second area A2 on the right and front of the robot 10b, and the front area of the robot 10a can be a third area A3 where the first area A1 and the second area A2 overlap.

Each of the first lidar 50 and the second lidar 60 may detect the third area A3, and when positioned on a plurality of legs 102 of the cart 100, each of the first lidar 50 and the second lidar 60 may detect the plurality of legs 102.

As illustrated in FIG. 5, the result sensed by the first lidar 50 may detect a cluster (lidar points Lp) within an area LA corresponding to the leg 102 of the cart 100, and as illustrated in FIG. 5, the result sensed by the second lidar 60 may detect a cluster (lidar points Lp) located within an area LA corresponding to the leg 102 of the cart 100.

At least one of the roll and pitch of the first lidar 50 and the second lidar 60 may be different from each other. The first lidar 50 and the second lidar 60 may be installed with the same yaw.

Roll ψ can be the angle of rotation with respect to the x-axis, pitch θ can be the angle of rotation with respect to the y-axis, and yaw Φ can be the angle of rotation with respect to the z-axis.

A pair of lidars 50, 60 may detect the legs 102 of the cart 100, and the robot 10a may drive the robot 10a to a docking position under the cart 100 based on the detection results from the pair of lidars 50, 60.

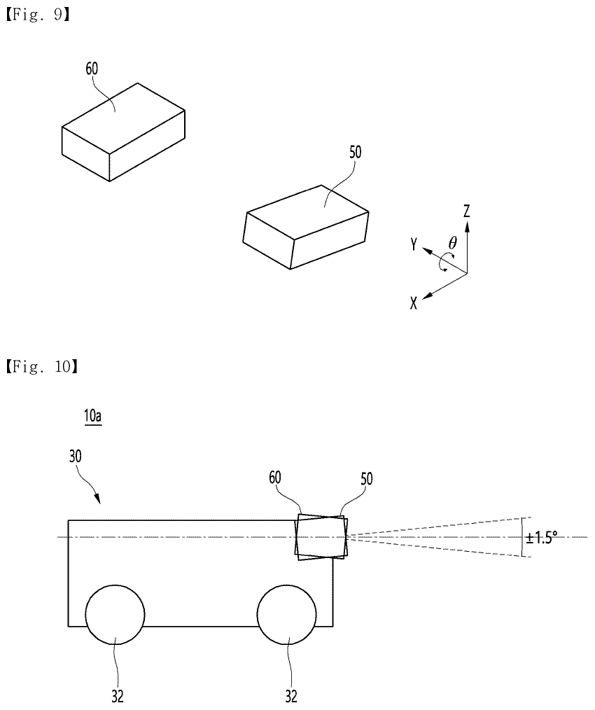

FIG. 8 is a perspective view illustrating a pair of lidars according to the present embodiment when the rolls are installed differently.

The first lidar 50 and the second lidar 60 may be installed so that the roll angle ψ differs by 0.1° to 3°. For example, the first lidar 50 and the second lidar 60 may be installed so that the difference in the roll angle ψ occurs by 0.5°, 1.5°, or 3°.

For example, the second lidar 60 may be installed so that the roll angle ψ is 0° with respect to the roll axis X, and the first lidar 50 may be installed so that the roll angle ψ is 0.5° with respect to the roll axis X.

As another example, the first lidar 50 is installed so that the roll angle ψ is +1.5° with respect to the roll axis X, and the second lidar 60 is installed so that the roll angle ψ is −1.5° with respect to the roll axis X.

FIG. 9 is a perspective view illustrating a pair of lidars according to the present embodiment when the pitches are installed with differently.

The first lidar 50 and the second lidar 60 may be installed so that the pitch angle θ differs by 0.1° to 3°. For example, the first lidar 50 and the second lidar 60 may be installed so that the difference in pitch angle θ occurs by 0.5°, 1.5°, or 3°.

For example, the second lidar 60 may be installed so that the pitch angle θ is 0° with respect to the pitch axis Y, and the first lidar 50 may be installed so that the pitch angle θ is 0.5° with respect to the pitch axis Yw.

As another example, the first lidar 50 may be installed so that the pitch angle θ is +1.5° with respect to the pitch axis Yw, and the second lidar 60 may be installed so that the pitch angle θ is −1.5° with respect to the pitch axis Yw.

When the pitch angles θ of the first lidar 50 and the second lidar 60 are different, the first lidar 50 can be disposed to be inclined so as to face upward toward the front, and the second lidar 60 can be disposed to be inclined so as to face downward toward the front.

The first lidar 50 can be installed so as to be inclined upward with respect to the horizontal plane, and the maximum inclination angle of the first lidar 50 may be +1.5°.

The second lidar 60 can be installed so as to be inclined downward with respect to the horizontal plane, and the maximum inclination angle of the second lidar 60 may be −1.5°.

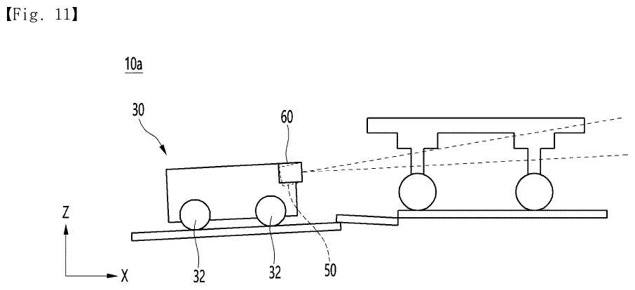

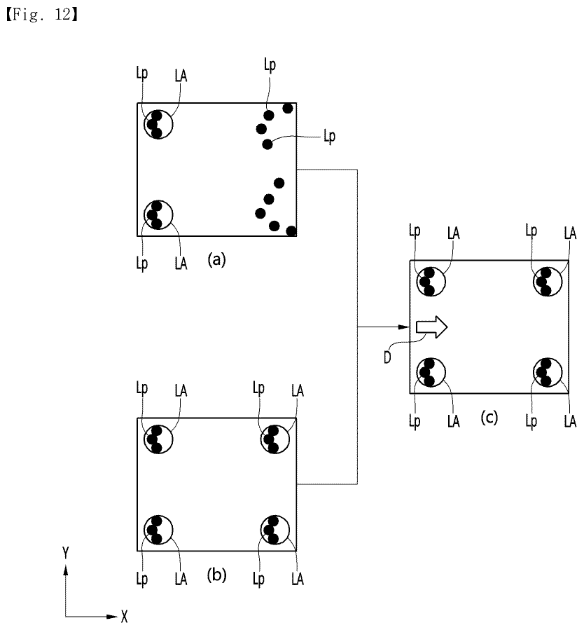

FIG. 10 is a side view illustrating a pair of lidars according to the present embodiment when the pitches are installed with differently; FIG. 11 is a side view illustrating an example of a robot according to the present embodiment when detecting a cart leg; and FIG. 12 is a view illustrating the sensing values of the first lidar and the sensing values of the second lidar illustrated in FIG. 11.

FIG. 12 (a) is an example illustrating the sensing value of the first lidar 50, and FIG. 12 (b) is an example illustrating the sensing value of the second lidar 60.

The processor 18 may control the driving module 30 based on the sensing results of the first lidar 50 and the sensing results of the second lidar 50.

As illustrated in FIG. 12 (a), the result sensed by the first lidar 50 can detect a cluster (lidar points Lp) larger than the area LA corresponding to the leg 102 of the cart 100, and as illustrated in FIG. 12 (b), the result sensed by the second lidar 60 can detect a cluster (lidar points Lp) located within the area LA corresponding to the leg 102 of the cart 100.

FIG. 12 (a) is the result in which the first lidar 50 fails to normally sense the leg 102 of the cart 100, and FIG. 12 (b) is the result in which the second lidar 60, which has at least one of the roll and pitch different from that of the first lidar 50, normally senses the leg 102.

The processor 18 may control the driving module 30 according to the sensing value of the lidar that normally senses the leg 102 of the cart 100 if at least one of the first lidar 50 and the second lidar 60 normally senses the leg 102 of the cart 100.

FIG. 12 (c) is a view illustrating a leg of the cart 100 when the robot 10a moves to the lower side of the cart 100 based on the normally sensed lidar 60.

If the second lidar 60 normally senses the leg 102 of the cart 100 as illustrated in FIG. 12 (b), the processor 18 may control the driving module 30 according to the sensing value of the second lidar 60, and the robot 10a can enter in the entry direction (D) illustrated in FIG. 12 (c) and enter the lower side of the cart 100, particularly the upper body 101 (see FIG. 4).

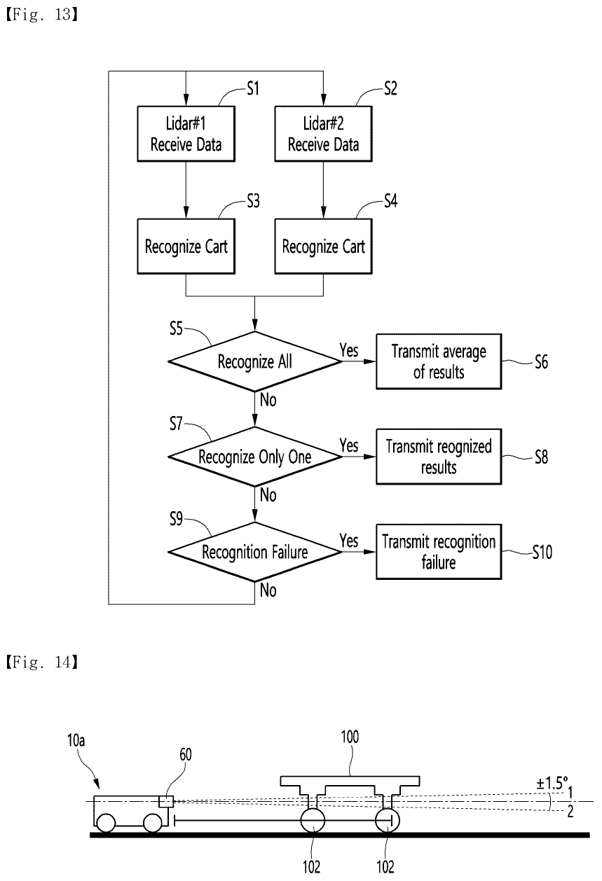

FIG. 13 is a flow chart for detecting the legs of a cart by a pair of lidars according to the present embodiment.

When the robot 100a is driving, each of the pair of lidars 50, 60 can receive data. (S1) (S2)

Data reception of the first lidar 50 and data reception of the second lidar 60 may be performed simultaneously or with a time difference.

The cart recognition module of the first lidar 50 may recognize the leg 102 of the cart 100. (S3)

The cart recognition module of the second lidar 60 may recognize the leg 102 of the cart 10. (S4)

When the first lidar 50 recognizes the leg 102 of the cart 100 and the second lidar 60 recognizes the leg 102 of the cart 100, the average of the results can be transmitted to the processor 18. (S5) (S6)

On the other hand, if only one of the first lidar 50 and the second lidar 60 recognizes the leg 102 of the cart 100, the recognition result may be transmitted to the processor 18. (S7) (S8)

If both the first lidar 50 and the second lidar 60 recognize the leg 102 of the cart 100, a failure of recognition can be transmitted to the processor 18. (S9) (S10)

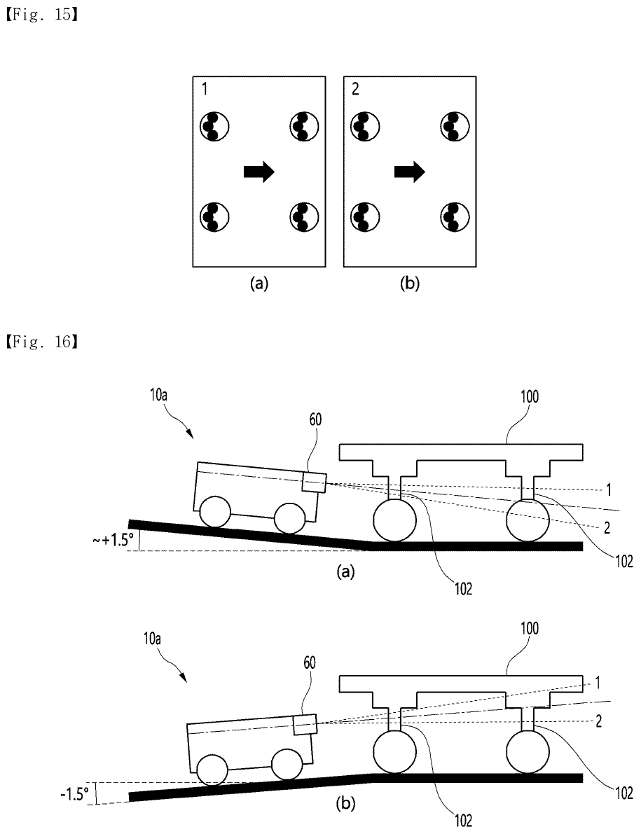

FIG. 14 is a side view illustrating when both a pair of lidars according to the present embodiment normally detect the legs of the cart; and FIG. 15 is a view illustrating an example of sensing values when both a pair of lidars according to the present embodiment normally detect the legs of a cart.

The robot 10a can be positioned at the same angle as the cart 100, as illustrated in FIG. 14. For example, both the robot 10a and the cart 100 may be positioned on a flat surface. The robot 10 a may approach the cart 100 within a predetermined distance (for example, 2 m), and the first lidar 50 and the second lidar 60 in which at least one of the roll and pitch is installed differently may recognize the leg 102 of the cart 100.

The example illustrated in FIG. 14 is a case where the first lidar 50 and the second lidar 60 are installed with different pitches. The first lidar 50 can be disposed to be tilted 1.5° in the front upper direction, and the second lidar 60 can be disposed to be tilted 1.5° in the front lower direction.

FIG. 15 (a) is an example illustrating the sensing value of the first lidar 50, and FIG. 15 (b) is an example illustrating the sensing value of the second lidar 60.

Both the first lidar 50 and the second lidar 60 may normally recognize the leg 102 of the cart 100. In this case, the first lidar 50 and the second lidar 60 can transmit the average of the results to the processor 18.

FIG. 16 is a side view illustrating when only one of a pair of lidars according to the present embodiment normally detects the leg of the cart; and FIG. 17 is a view illustrating an example of sensing values when only one of a pair of lidars according to the present embodiment normally detects the leg of a cart.

The robot 10a may be positioned at a different angle from the cart 100, as illustrated in FIG. 16. For example, as illustrated in FIG. 16 (a), the robot 10a may be positioned at a downward angle and the cart 100 may be positioned on a flat surface. For another example, as illustrated in FIG. 16 (b), the robot 10a may be positioned at an upward angle and the cart 100 may be positioned on a flat surface.

The robot 10a can approach the cart 100 within a predetermined distance (for example, 2 m), and one of the first lidar 50 and the second lidar 60 in which at least one of the roll and pitch is installed differently can recognize the leg 102 of the cart 100.

The example illustrated in FIG. 16 is a case where the first lidar 50 and the second lidar 60 are installed with different pitches. The first lidar 50 can be disposed to be tilted 1.5° in the front upper direction, and the second lidar 60 can be disposed to be tilted 1.5° in the front lower direction.

FIG. 17 (a), (b), and (c) are examples illustrating the sensing values of the first lidar 50, the sensing values of the second lidar 60, and the recognized result values when the robot is positioned on a downhill surface.

As illustrated in FIG. 16 (a), when the robot 10a is positioned on a downhill surface, the first lidar 50 can normally recognize the leg 102 of the cart 100, as illustrated in (a) of FIG. 17, but the second lidar 60 may not normally recognize the leg 100 of the cart 100, as illustrated in FIG. 17 (b).

In this case, one of the first lidar 50 and the second lidar 60 normally recognizes the leg 102 of the cart 100 and can transmit the recognized result value as illustrated in FIG. 17 (c) to the processor 18.

FIG. 17 (d), (e), and (f) are examples illustrating the sensing values of the first lidar 50, the sensing values of the second lidar 60, and the recognized result values when the robot is positioned on an uphill surface.

As illustrated in FIG. 16 (b), when the robot 10a is positioned on an uphill surface, the first lidar 50 may not normally recognize the leg 102 of the cart 100, as illustrated in FIG. 17 (d), and the second lidar 60 may normally recognize the leg 100 of the cart 100, as illustrated in FIG. 17 (e).

In this case, one of the first lidar 50 and the second lidar 60 normally recognizes the leg 102 of the cart 100 and can transmit the recognized result value as illustrated in FIG. 17 (f) to the processor 18.

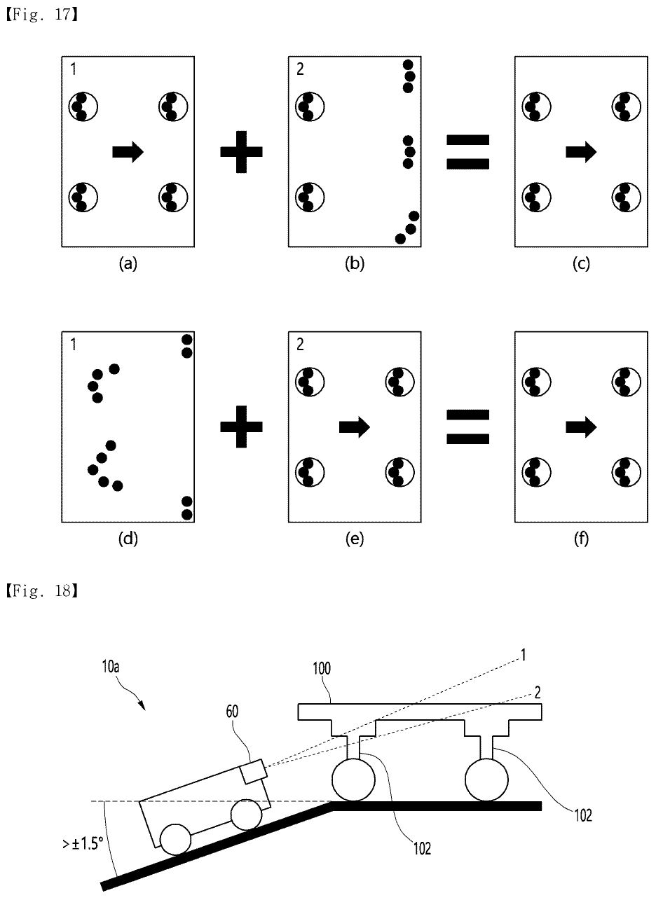

FIG. 18 is a side view illustrating a case where neither pair of lidars according to the present embodiment detects the legs of the cart normally; and FIG. 19 is a view illustrating an example of sensing values in a case where both a pair of lidars according to the present embodiment fail to normally detect the legs of a cart.

The robot 10a may be positioned at a different angle from the cart 100, as illustrated in FIG. 18. For example, as illustrated in FIG. 18, the robot 10a may be positioned at an upward incline and the cart 100 may be positioned on a flat surface, and the incline of the surface on which the robot 10a is positioned may be steep.

The example illustrated in FIG. 18 is a case where the first lidar 50 and the second lidar 60 are installed with different pitches. The first lidar 50 can be disposed to be tilted 1.5° toward the front upper direction, and the second lidar 60 can be disposed to be tilted 1.5° toward the front lower direction.

The robot 10a may approach the cart 100 within a predetermined distance (for example, 2 m), and if the slope of the uphill surface is too large, both the first lidar 50 and the second lidar 60, which are installed with at least one of the roll and pitch different from each other, may not recognize the leg 102 of the cart 100.

As illustrated in FIG. 18, when the robot 10a is positioned on a steep uphill surface, the first lidar 50 may not normally recognize the leg 102 of the cart 100, as illustrated in FIG. 19 (a), and the second lidar 60 may not normally recognize the leg 100 of the cart 100, as illustrated in FIG. 19 (b).

In this case, both the first lidar 50 and the second lidar 60 fail to normally recognize the leg 102 of the cart 100 and may transmit the failure of recognition to the processor 18.

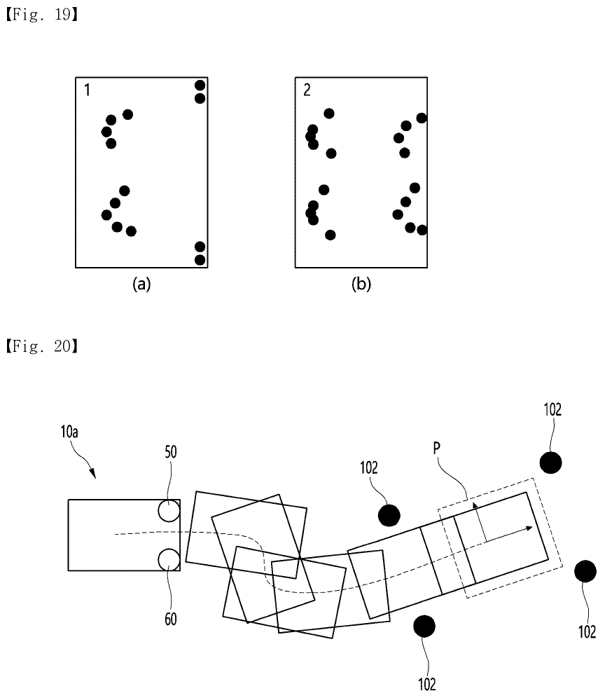

FIG. 20 is a plan view illustrating a robot according to the present embodiment when moving to a docking position.

The method for operating the robot may include a step (that is, a sensing step) in which at least one of the roll and pitch of the first lidar 50 and the second lidar 60 different from each other, sense the leg 102 of the cart 100.

In addition, the method for operating the robot may further include a step (that is, a docking step) of driving the driving module 30 to the docking position P of the cart 100 if at least one of the first lidar 50 and the second lidar 60 normally recognizes the leg 102 of the cart 100.

The docking position P may be a position on the lower side of the upper body 101 as illustrated in FIG. 4.

The processor 18 may drive the driving module 30 to the docking position P of the cart 100 if at least one of the first lidar 50 and the second lidar 60 normally recognizes the leg 102 of the cart 100 based on the sensing results of the first lidar 50 and the second lidar 60.

During the docking phase, the robot 10a may approach the cart 100 while changing direction, as illustrated in FIG. 20, and can drive to the docking position P through some of the plurality of legs 102 of the cart 100.

The method for operating the robot may further include a step of raising the lift 40 disposed on the driving module 30 when the driving module 30 reaches the docking position (P) of the cart 100 (that is, a lift raising step).

The processor 18 can stop the driving module 30 when the robot 10a reaches the docking position P, and then raise the cart 100 by using the lift 40.

The method for operating the robot may further include a step (that is, driving step) of driving the driving module 30 to the destination after the lift 40 is raised.

The processor 18 can drive the driving module 30 to a destination, and can stop the driving module 30 when the driving module 30 reaches the destination.

The method for operating the robot may further include a step of lowering the lift 40 after the driving step (that is, a lift lowering step).

The processor 18 can lower the lift 40 after reaching the destination.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

What is claimed is:

1. A robot comprising:
a driving module;
a lift installed on an upper side of the driving module;
a first lidar disposed on one side of the driving module;
a second lidar disposed spaced apart from the first lidar on the driving module, and
a processor configured to control the driving module according to sensing results of the first lidar and sensing results of the second lidar,
wherein at least one of a roll and pitch of the first and second lidars is different from each other.

2. The robot of claim 1,
wherein the processor configured to drive the driving module to a docking position of a cart if at least one of the first lidar and the second lidar normally recognizes a leg of the cart.

3. The robot of claim 1,
wherein the first lidar and the second lidar have the same yaw.

4. The robot of claim 1,
wherein the first lidar and the second lidar are disposed spaced apart from each other in front surface of the driving module in a left and right direction, and
wherein the first lidar is disposed to be inclined toward a front upper direction.

5. The robot of claim 4,
wherein a maximum inclination angle of the first lidar is +1.5°.

6. The robot of claim 4,
wherein the second lidar is disposed to be inclined toward a front lower direction.

7. The robot of claim 6,
wherein a maximum inclination angle of the second lidar is −1.5°.

8. A method for controlling a robot, comprising:
sensing a leg of a cart by a first lidar and a second lidar in which at least one of the roll and pitch is installed differently; and
driving a driving module to a docking position of the cart if at least one of the first lidar and the second lidar normally recognizes the leg of the cart.

9. The method for operating a robot of claim 8, further comprising:
raising a lift disposed on the driving module if the driving module reaches the docking position of the cart.

10. The method for operating a robot of claim 9, further comprising:
driving a driving module to a destination after the lift is raised.
